(19) United States
(12) Patent Application Publication
(10) Pub. No.: US 2010/0331465 A1
(43) Pub. Date: Dec. 30, 2010

(54) TPE COMPOSITION HAVING GOOD CLARITY AND LOW HARDNESS AND ARTICLES FORMED THEREFROM

(75) Inventor: Xia Zhao, Malvern, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: WEST PHARMACEUTICAL SERVICES, INC., Lionville, PA (US)

(21) Appl. No.: 12/666,089

(22) PCT Filed: Jul. 2, 2008
(86) PCT No.: PCT/US08/69016

§ 371 Date: Dec. 22, 2009

Related U.S. Application Data
(63) Continuation-in-part of application No. 60/948,307, filed on Jul. 6, 2007.

(51) Int. Cl. C08L 53/00; C08K 5/5419

(52) U.S. Cl. 524/261; 524/505

(57) ABSTRACT

A thermoplastic elastomer (TPE) composition is provided which has a first high vinyl styrenic block copolymer (SBC) having a number average molecular weight (Mn) less than about 120,000 Daltons (Da) and a second high vinyl SBC having a Mn greater than about 120,000 Da; a polyolefin; and a plasticizer compatible with the first and second SBCs. An article formed from such a TPE composition has a tensile strength greater than 600 psi, a hardness less than 45 Shore A, and a haze less than 20 percent, preferably less than 15 percent, when the thickness of the article is 1.7 mm, and wherein the physical dimensions of the article remain substantially unchanged after immersion of the article in boiling water for one hour.

### BACKGROUND OF THE INVENTION

The present invention is directed to a thermoplastic elastomer (TPE) composition having low hardness while also maintaining excellent clarity, low haze, temperature stability, moldability, tear strength, and tensile strength.

TPEs are elastic and flexible polymers which exhibit similar physical properties as elastomers, but are recyclable and easier to process. Compositions made from TPEs are widely used in applications which have traditionally employed silicones (polysiloxanes) and other thermoset rubbers, which do not melt. Articles can be formed from TPE compositions to have similar physical properties as their elastomer counterparts while also being injection moldable, which reduces the cost of production and allows the TPE article to be recycled. TPE compositions can thus be injection molded to form articles such as bottle nipples for infants, teething rings, pacifiers, medical devices, and other devices that would otherwise be formed from silicone.

TPEs are easier to process than elastomers because they are crosslinked by non-covalent bonds (secondary interactions). At room temperature, TPEs behave like crosslinked elastomers. However, at elevated temperatures, they behave as linear polymers. Thus, TPEs, unlike elastomers, have reversible properties as the temperature increases or decreases. The reversible crosslink allows articles formed from TPE compositions to be melted and reformed.

A TPE can be formed from block copolymers or from blocks of homopolymer having various tacticity within its chains. The elastomeric properties of thermoplastic elastomers result from the phase separation between the blocks. One of the blocks forms a continuous phase, which provides rubbery properties, while another block is glassy or crystalline. The glassy/crystalline blocks provide the crosslinks for the blocks of the continuous phase.

In the case of block copolymers, styrene is frequently used as the glassy/crystalline block that crosslinks with other polymer blocks. Block copolymers that contain styrene are known as styrenic block copolymers, or SBCs. Examples of SBCs include SBS block copolymer (styrene-butadiene-styrene), SIS block copolymer (styrene-isoprene-styrene), and SUBS block copolymer (styrene-isoprene/butadiene-styrene). SBS, SIS, and SUBS block copolymers can be hydrogenated to yield the hydrogenated styrenic block copolymers (HSBCs), such as SEBS (styrene-ethylenebutylene-styrene), SEPS (styrene-ethylene/propylene-3-methylbutene-styrene), and SEEPS (styrene-ethylene-ethylene/propylene-styrene).

In general, TPE compositions are formed by blending TPEs, polyolefins, and additives, such as plasticizers, stabilizers, and lubricants. The polyolefin functions as the continuous phase of the TPE composition. Polypropylene is the polyolefin typically selected for the continuous phase of many TPE compositions.

U.S. Pat. No. 6,984,688 (the '688 patent) describes a blend of two HSBCs having a butadiene mid-block, blended with a polyolefin to form a TPE composition having a specific clarity, haze, temperature stability, moldability, tear strength, and tensile strength. In particular, the '688 patent demonstrates that improved clarity can be achieved by using “high vinyl” SBCs.

The '688 patent discloses selecting a SBC having a number average molecular weight (Mn) of 130,000 to be blended with a SEEPS block copolymer as the TPE component of the TPE composition. The SEEPS block copolymer is also described as having a Mn of less than 130,000. An article formed from this composition has a limited softness. That is, it does not exhibit a hardness level below 45 Shore A. As described in the '688 patent, it is difficult to achieve all of the above mentioned characteristics simultaneously in a TPE composition, because a trade-off exists between characteristics such as hardness and heat stability with characteristics such as clarity.

For example, it is possible to achieve greater softness in the TPE composition described in the '688 patent by adding larger amounts of plasticizer to the TPE composition. However, when large amounts of plasticizer are added to a TPE composition, the composition becomes soapy and loses its melt strength. Such compositions have physical properties that are undesirable.

Also, it is possible to achieve greater tear and tensile strength by using a SBC having a number average molecular weight greater than 150,000, but the use of such greater molecular weight SBC does not provide a substantially transparent material when blended with sufficient polypropylene to achieve a hardness below 65 Shore A. Conversely, using a SBC with relatively low molecular weight yields a material having low tensile and tear strength when blended with sufficient polypropylene to achieve a hardness below 65 Shore A.

Accordingly, it would be desirable to have a TPE composition which has a hardness below 45 Shore A, while still maintaining the desired levels of clarity, haze, temperature stability, moldability, tear strength, and tensile strength.

### BRIEF SUMMARY OF THE INVENTION

According to a first aspect, the present invention provides for a thermoplastic elastomer composition comprising a blend of: at least a first and second hydrogenated styrenic block copolymers, wherein the first hydrogenated styrenic block copolymer has a number average molecular weight less than about 120,000 Da, and greater than about 50 mole percent of a butadiene mid-block copolymerized at the 1,2-position prior to hydrogenation, and/or a butadiene and isoprene mid-block copolymerized prior to hydrogenation, and/or an isoprene mid-block copolymerized prior to hydrogenation, and wherein the second hydrogenated styrenic block copolymer has a number average molecular weight greater than about 120,000 Da, and greater than about 50 mole percent of a butadiene mid-block copolymerized at the 1,2-position prior to hydrogenation, and/or a butadiene and isoprene mid-block copolymerized prior to hydrogenation, and/or an isoprene mid-block copolymerized prior to hydrogenation; a polyolefin; and a plasticizer compatible with the midblocks of the first and second hydrogenated styrenic block copolymers. TPE compositions of the present invention can be used to form articles such as bottle nipples for infants, teething rings, pacifiers, medical devices, and other devices that would otherwise be formed from conventional elastomers.

According to another aspect, the present invention provides for an article comprising the thermoplastic elastomer composition according to the first aspect above, wherein the article includes: a tensile strength greater than 600 psi; a hardness less than 45 Shore A; a haze less than 20 percent when a thickness of the article is 1.7 mm, and a haze less than 30 percent when the article has a thickness of 3.5 mm, as measured by ASTM D1003; and wherein physical dimensions of the article remain substantially unchanged after immersion of the article in boiling water at standard temperature and pressure for one hour.

According to yet another aspect, the present invention provides for an article comprising: a thermoplastic elastomer characterized by the following properties: a tensile strength greater than 600 psi; a hardness less than 45 Shore A; a haze less than 20 percent when a thickness of the article is 1.7 mm, and a haze less than 30 percent when the article has a thickness of 3.5 mm, as measured by ASTM D1003; and wherein physical dimensions of the article remain substantially unchanged after immersion of the article in boiling water at standard temperature and pressure for one hour.

### DETAILED DESCRIPTION OF THE INVENTION

The present invention provides for TPE compositions that include a thermoplastic elastomer component (TPE component), a polyolefin component, and a plasticizer. The TPE composition can also optionally include a stabilizer component and/or a lubricant.

The TPE component typically contains at least two high vinyl SBCs, a first SBC having a relatively low molecular weight (e.g., a molecular weight lower than a second SBC component) and a second SBC having a relatively high molecular weight (e.g., a molecular weight higher than the first SBC component). This combination of higher and lower molecular weight high vinyl SBCs advantageously achieves a desirable hardness level below 45 Shore A in the resulting TPE composition, while still maintaining acceptable clarity, haze, temperature stability, moldability, tear strength, and tensile strength.

As used herein, the term “high vinyl” means greater than about 50 mole percent of the butadiene mid-block polymerized at the 1,2-position, and if present, greater than about 50 mole percent of the isoprene polymerized at the 3,4-position. Butadiene and isoprene midblocks that are thus polymerized yield polymer chains having pendant vinyl groups. Since the conventional process of polymerizing SBCs normally does not yield a high amount of vinyl groups, these so called high vinyl SBCs are referred to as having a modified elastomeric midblock.

Preferred high vinyl SBCs with relatively low molecular weight include hydrogenated styrenic block copolymers having a number average molecular weight less than about 120,000 Da, less than about 115,000 Da, and less than about 90,000 Da. Preferred high vinyl SBCs with relatively high molecular weight include hydrogenated styrenic block copolymers having a number average molecular weight greater than about 120,000 Da, greater than about 130,000 Da, and greater than about 150,000 Da. Such hydrogenated styrenic block copolymers have greater than about 50 mole percent of a butadiene mid-block copolymerized at the 1,2-position prior to hydrogenation, and/or a butadiene and isoprene mid-block copolymerized prior to hydrogenation, and/or an isoprene mid-block copolymerized prior to hydrogenation. Preferred SBCs applicable to the present invention include hydrogenated styrenic block copolymers, and more preferably SEBS and SEEPS.

One example of a high vinyl SEBS block copolymer having a relatively high molecular weight is KRATON® G1641 polymer, supplied in powder form by the Kraton Polymers Group of Companies. KRATON® G1641 has a polystyrene content of 33-34 percent by weight, a hardness of 64 Shore A, and a number average molecular weight of more than 130,000 Da. An example of a SEBS block copolymer having a relatively low molecular weight is KRATON® 1643 polymer. KRATON® 1643 is supplied as a dusted, dense pellet, having a polystyrene content of 18-22 percent by weight, a hardness of 52 Shore A, and a number average molecular weight of 110,000 Da. KRATON® 1643 has modified ethylene/butylene midblocks that increase the compatibility, dispersibility, and clarity when blended with polypropylene. Its clarity is attributed to its index of refraction, which is similar to that of polypropylene, thereby providing clarity in the resulting blend. It is believed that the vinyl pendant groups along the modified ethylene/butylene midblock establish the desired index of refraction. More conventional (i.e., non-high vinyl) SEBS block copolymers, such as KRATON® G1652 or KRATON® G1650 blend well with polypropylene, but are not known to provide comparable clarity in a resulting TPE composition.

An example of SEEPS block copolymer having a relatively high Mw is SEPTON™ 4044 polymer supplied in powder form by Kuraray Co. SEPTON™ 4044 has a polystyrene content of 32 percent by weight, a hardness of about 76 Shore A, and a number average molecular weight of about 150,000 Da. An example of SEEPS with a relatively low molecular weight is SEPTON™ 4033 polymer, supplied in powder form by Kuraray Co. SEPTON™ 4033 has a polystyrene content of 30 percent by weight, a hardness of 76 Shore A, and a number average molecular weight of about 90,000 Da.

The TPE composition can be blended with about 10 wt. % to less than about 50 wt. % of a hydrogenated styrenic block copolymer having a number average molecular weight greater than 120,000 Da. The TPE composition can also be blended with about 50 wt. % to about 90 wt. % of a hydrogenated styrenic block copolymer having a number average molecular weight less than 120,000 Da.

The polyolefin resin component (“polyolefin component”) provides a continuous phase in the TPE composition. The amount of polyolefin component in the thermoplastic elastomer composition of the present invention is from about 1 to 40 parts by weight, preferably from about 10 to 35 parts by weight, and more preferably from about 15 to 30 parts by weight, relative to 100 parts by weight of the SBC TPE component.

The melting point of the polyolefin component is typically above 130° C. The polypropylene can be homopolymers and copolymers of various tacticity. Either clarified random polypropylene copolymers, clarified polypropylene homopolymers, or a combination of both may be selected.

Examples of random polypropylene copolymers include copolymers of propylene and an α-olefin, such as ethylene or 4-methyl-1-pentene (PP9074MED, supplied by ExxonMobil Chemical). Suitable clarified polypropylene homopolymers include, for example, Total Petrochemicals M3282MZ, which has a melting point of 153° C. The polyolefin component typically has greater than 70 percent isotactic linkages, and its melt flow rate is in the range from 10 to 100 g/10 min, in accordance with ASTM D1238. Preferably, the polyolefin is polypropylene.

A plasticizer (also referred to as a softening agent), is added to the TPE composition to reduce the hardness and increase the elasticity of the TPE composition. The plasticizer should be compatible with the rubbery phases (i.e., elastomeric midblocks of the HSBC) of the TPE composition. Characteristics such as kinematic viscosity, weight average molecular weight, solubility parameter, and flashpoint should be considered in selecting the plasticizer to be added. Exemplary plasticizers applicable to the present invention include those having a kinematic viscosity between 10 and 500 mm²/sec at 40° C., a weight average molecular weight less than 2,000, a solubility parameter that is +/−20% of that of the elastomeric mid-block, a flashpoint above 100° C., and which are in liquid form at room temperature. Such plasticizers can be selected from a variety of essentially colorless non-aromatic compounds that are mineral oil, vegetable oil, or synthetic based. Preferred plasticizers include BRITOL® 50T (USP white oil) and Indopol® L-50 (polyisobutene).

The amount of plasticizer contained in the TPE compositions of the present invention is from about 50 to 180 parts by weight, preferably from about 70 to 160 parts by weight, and more preferably from about 80 to 150 parts by weight, relative to 100 parts by weight of the SBC TPE component.

The TPE compositions of the present invention can also include a stabilizer component. Stabilizers applicable to the present invention include antioxidants, such as hindered phenols. Exemplary stabilizers include those commercially known as IRGANOX® 1010 and IRGANOX® 1076 of Ciba Specialty Chemicals and CYANOX® LTDP (Dilaurylthiodipropionate), commercially sold by Cytec. These antioxidants trap free radicals formed upon heating in the presence of oxygen and prevent discoloration or change in the mechanical properties of the TPE composition.

The amount of stabilizer contained in the TPE compositions of the present invention is from about 0.01 to 1.0 parts by weight, preferably from about 0.05 to 0.8 parts by weight, and more preferably from about 0.1 to 0.5 parts by weight, relative to 100 parts by weight of the SBC TPE component.

The TPE compositions of the present invention can further include a lubricant. The lubricant can be added to ease the release of an article molded from the TPE composition from a mold cavity. The lubricant also provides a slippery feel to the molded article, which would otherwise be tacky due to the physical properties of the block copolymer.

Lubricants applicable to the present invention can include, for example, LOXIOL® HOB7107 and L45/10 Momentive silicone. However, any other lubricant known in the art and compatible with thermoplastic elastomers may be used in accordance with the present invention. For example, compatible silicones include those that exhibit no phase separation from the TPE in the TPE composition. Such compatible silicones include low viscosity silicones, and preferably silicones having a viscosity below 350 centistokes (cs). As used hereinafter, the term “low viscosity silicone” refers to silicones compatible with the TPE compositions such that no phase separation with the TPE is exhibited.

In producing the TPE compositions of the present invention, the components for the TPE composition can be blended by any known method. To obtain a homogeneous TPE composition, the above mentioned components can be dry blended, prior to melt-kneading, using a mixer, such as a Henschel mixer, a tumbler, a ribbon blender, or the like, and then melt-kneaded using a conventional kneader, such as a mixing roll, a kneader, a Banbury mixer, an extruder, or the like. Examples of molding methods useable for forming articles from the TPE composition of the present invention include injection molding, extrusion molding, compression molding, blow molding, and the like.

### EXAMPLES

Test plaques were formed from formulations described in the examples below. The following tests were performed on test plaques in each of the examples: ASTM D412 (tensile strength), ASTM D1003 (haze), and ASTM D2240 (hardness). In addition, percent elongation of the test sample was measured after tensile testing, and clarity assessed by a visual comparison of the test samples. For each test sample plaque, the clarity of the sample was assigned a relative ranking: “1” being the best of the lot for clarity, “2” being the second best for clarity of the lot, and so on. The test plaques were compression molded at 350° F., a heating cycle of 5 minutes, a hot compression cycle of 1.5 minutes, and a cooling cycle of 17 minutes.

Table 1 below provides a list of all the components used to form the TPE compositions in the following examples.

TABLE 1

| Component | Trade Name | Generic Name |
|---|---|---|
| SBC TPE | KRATON ® 1641 | High vinyl content SEBS with |
| | | Mn of about 130,000 Da |
| SBC TPE | KRATON ® 1643 | High vinyl content SEBS with |
| | | Mn of about 110,000 Da |
| SBC TPE | SEPTON ™ 8006 | Regular (non-high vinyl) SEBS |
| SBC TPE | KRATON ® D1114P | SIS |
| SBC TPE | SEPTON ™ 4033 | SEEPS with Mn of about |
| | | 150,000 Da |
| SBC TPE | SEPTON ™ 4044 | SEEPS with Mn of about |
| | | 90,000 Da |
| Lubricant | L45/10 Momentive | Poly(dimethyl siloxane) |
| | Silicone | |
| Lubricant | SF18-350 Momentive | Poly(dimethyl siloxane) |
| | Silicone | |
| Lubricant | LOXIOL ® HOB7107 | Hydrogenated castor oil/ |
| | | Pentaerythritoladipatestearate |
| Polyolefin | Exxon PP9074 | Polypropylene co-polymer |
| Polyolefin | Total M3282MZ | Clarified Polypropylene |
| | | homopolymer polymerized |
| | | by Metallocene |
| Plasticizer | BRITOL ® 50T | USP white mineral oil |
| Plasticizer | Indopol ® 50 | Polyisobutene |
| Stabilizer | IRGANOX ® 1010 | Methylene (3,5-di-tert-butyl-4- |
| (antioxidant) | | hydrozyhydrocinnamate) methane |
| Stabilizer | CYANOX ® LTDP | Dilauryl Thiodipropionate |
| (antioxidant) | | |

### Example 1

### TPE Compositions A-F

Six different TPE compositions (labeled A through F) were formed to demonstrate the effect of high vinyl versus non-high vinyl SBC on the clarity of the TPE composition. The compositions contained a polypropylene polyolefin, a plasticizer, and a SBC.

The TPE compositions each contained the same type and amount of polyolefin and plasticizer: 15 parts of Exxon PP9074 polypropylene copolymer per 100 parts SBC; and 120 parts of BRITOL® 50T plasticizer per 100 parts SBC. The TPE compositions each contained 100 parts of one or more of the following SBC components: KRATON® 1641 (a high vinyl high molecular weight SEBS), KRATON® MD 1643 (a high vinyl low molecular weight SEBS), SEPTON™ 8006 (a non-high vinyl SEBS), and KRATON® D1114P (a non-high vinyl SIS). The amount of each SBC per TPE composition is as specified in Table 2 below. The mixing was performed in a BRABENDER® mixer (manufactured by BRABENDER® GmbH & Co. KG) with a batch size of 250 grams at 380° C. for 3 minutes.

Samples of the TPE compositions were tested for tensile strength, hardness, and ultimate elongation. The clarity of the samples were compared against each other and given a relative ranking for clarity. The test results for tensile strength, hardness, clarity, and ultimate elongation are set forth in Table 2 below.

TABLE 2
Comparison of different SBC components.

| TPE Compositions | | A | B | C | D | E | F |
|---|---|---|---|---|---|---|---|
| SBC | KRATON ® 1641 | 100 | | 75 | | 75 | |
| Components | KRATON ® MD 1643 | | | 25 | 25 | | 50 |
| | SEPTONTM 8006 | | 100 | | 75 | | 50 |
| | KRATON ® D1114P | | | | | 25 | |
| | Total parts SBC | 100 | 100 | 100 | 100 | 100 | 100 |
| Results | Tensile Strength (psi) | 936 | 1027 | 845 | 369 | 774 | 150 |
| | Hardness (Shore A) | 23 | 34 | 23 | 29 | 19 | 26 |
| | Relative Clarity Ranking | 2 | 3 | 1 | 5 | 6 | 4 |
| | Ultimate Elong. % | 1039* | 827 | 1101* | 644 | 1063* | 417 |

*Sample not broken.

Table 2 shows that TPE compositions blended from SEBS block copolymer with high vinyl content generally improves clarity compared to TPE compositions blended from non-high vinyl SEBS. TPE composition C, which contained a mixture of high vinyl high molecular weight and high vinyl low molecular weight SEBS block copolymers (KRATON® 1641 and KRATON® 1643), provided the best clarity. Compositions B, F, D, and E, which were ranked lowest in clarity, all contained non-high vinyl SBC components.

### Example 2

### TPE compositions G-I

Two different TPE compositions, labeled as G and H, were formed from a blend of a polyolefin, a plasticizer, two different high vinyl SEBS block copolymer, a stabilizer, and a lubricant. The polyolefin Exxon PP9074 (a propylene co-polymer) was added in parts per 100 parts SBC. The high vinyl SEBS block copolymers were KRATON® 1641 (a high vinyl high molecular weight SEBS) and KRATON® MD 6932M (a high vinyl low molecular weight SEBS). TPE compositions G and H contained the same type and amount of plasticizer, lubricant, and stabilizer: 90 parts BRITOL® 50T plasticizer per 100 parts SBC, 0.5 parts LOXIOL® HOB7107 lubricant per 100 parts SBC; 0.4 parts IRGANOX® 1010 stabilizer per 100 parts SBC, and 0.4 parts CYANOX® LDTP stabilizer per 100 parts SBC. An additional lubricant, L45/10 GE Silicone, was also added in parts per 100 parts SBC to the TPE compositions G and H. The mixing was performed in an 18 mm PRISM twin screw extruder (manufactured by Thermo Electron Corporation).

An additional TPE composition, labeled I, which is similar to TPE composition C of Example 1, is compared below with Compositions G and H. The test results for tensile strength, hardness, clarity, and ultimate elongation are set forth in Table 3 below.

TABLE 3
Comparison of proportions of SEBS block copolymers.

| TPE Compositions | | G | H | I |
|---|---|---|---|---|
| SEBS SBC | KRATON ® 1641 (parts) | 75 | 50 | 75 |
| Components | KRATON ® MD 6932M | 25 | 50 | 25 |
| | (parts) | | | |
| | Total parts SEBS SBC | 100 | 100 | 100 |
| | Exxon PP9074 | 18 | 8 | 18 |
| | L45/10 GE Silicone | 1.8 | 0.5 | 0 |
| Results | Tensile Strength (psi) | 1040 | 479 | 845 |
| | Hardness (Shore A) | 35 | 26 | 23 |
| | Relative Clarity Ranking | 2 | 1 | 2 |
| | Ultimate Elong. % | 861 | 548 | 1101* |

*Sample not broken.

Table 3 shows that a TPE composition having a greater percentage of high vinyl low molecular weight SEBS blended with high vinyl high molecular weight SEBS (i.e., TPE composition H) improves the overall clarity of the TPE component. In addition, Table 3 shows that a TPE composition having a greater percentage of high vinyl high molecular weight SEBS improves the overall tensile strength of the TPE component.

### Example 3

### Compositions J-M

Each TPE composition J through M contained the same high vinyl SEBS block copolymer components: 75 parts KRATON® 1641 (a high molecular weight SEBS block copolymer with a Mn no more than 130,000 Da) and 25 parts KRATON® 1643 (a low molecular weight SEBS block copolymer with a Mn of about 110,000 Da). Each TPE composition also contained the same amounts of the following (in parts per 100 parts SEBS block copolymer): 0.2 parts IRGANOX® 1010 (stabilizer), 0.2 parts CYANOX® LTDP (stabilizer), 0.5 parts LOXIOL®HOB7107 (lubricant), and 1.8 parts L45/10 GE Silicone (lubricant). The polyolefin components added to the TPE compositions, in the amounts specified below in Table 4, were Exxon PP9074 (a polypropylene co-polymer) and M3282MZ (clarified polypropylene homopolymers polymerized by a metallocene catalyst). The plasticizer components added to the TPE compositions, in the amounts specified below in Table 4, were BRITOL® 50T (a white mineral oil) and Indopol® 50 (a polyisobutene). The test results for tensile strength, hardness, clarity, ultimate elongation, and percent haze are set forth in Table 4 below.

TABLE 4
Comparison of TPE compositions with differing
plasticizer and polyolefin components.

| TPE Compositions | | J | K | L | M |
|---|---|---|---|---|---|
| Polyolefin | PP9074 | 18 | 18 | 0 | 0 |
| | M3282MZ | 0 | 0 | 18 | 18 |
| Plasticizer | BRITOL ® 50T | 90 | 0 | 90 | 0 |
| | Indopol ® 50 | 0 | 90 | 0 | 90 |
| Results | Tensile Strength (psi) | 900 | 1070 | 1210 | 1100 |
| | Hardness (Shore A) | 34 | 33 | 36 | 35 |
| | Relative Clarity Ranking) | 4 | 2 | 3 | 1 |
| | Ultimate Elong. % | 850 | 1000 | 970 | 940 |
| | % Haze @ 67 mil | 14 | 13 | 14 | 13 |
| | % Haze @135 mil | 25 | 22 | 24 | 19 |

Table 4 shows TPE compositions blended with different combinations of plasticizers and polyolefins. Two types of plasticizer and two types of polyolefin were used in blending TPE compositions J-M. TPE compositions J-M are examples of TPE plaque samples which exhibit the desired combination of high clarity, hardness and tensile strength. The percent haze was measured by Total Petrochemicals.

Table 4 further shows that a hardness less than 45 Shore A of an article formed from a TPE composition can be achieved when the thermoplastic elastomer component of the TPE composition comprises two SBCs, the first SBC component having a Mn less than about 120,000 Da and the second SBC component having a Mn greater than about 120,000 Da.

TPE composition M was also evaluated for dimensional stability by immersion in boiling water at standard temperature and pressure (STP) for a one hour time period. The dimensions of the TPE plaque sample before and after immersion are shown in Table 5.

TABLE 5
Dimensional evaluations from boiling test.

| Dimensions | Length (mm) | Width (mm) | Thickness (mm) |
|---|---|---|---|
| M (before immersion) | 41 | 20.2 | 3.4 |
| M (after immersion) | 41 | 20.2 | 3.4 |

As shown in Table 5, the overall dimensions of plaque sample TPE composition M remained unchanged after immersion in boiling water after 1 hour.

### Example 4

### TPE Compositions N and O

Each TPE composition N and O contained the same SEEPS block copolymer components: 90 parts SEPTON™ 4033 (a low molecular weight SEEPS with a Mn of about 90,000 Da) and 10 parts SEPTON™ 4044 (a high molecular weight SEEPS with a Mn of about 150,000 Da) per 100 parts SBC. Each TPE composition also contained the same amounts of the following (in parts per 100 parts SBC block copolymer): 25 parts M3282MZ (polyolefin), 130 parts Birtol 50T (lubricant), 0.5 parts LOXIOL® HOB7107 (lubricant), and 0.2 parts CYANOX®LTDP (stabilizer). An additional high viscosity or low viscosity silicone lubricant was also added in parts per 100 parts SBC in the amounts specified below in Table 6. The low viscosity silicone was L45/10, from Momentive Performance Materials, having a viscosity of about 10 cs. The high viscosity silicone was SF18-350 having a viscosity of about 350 cs. The test results for tensile strength, hardness, clarity, and ultimate elongation, are set forth in Table 5 below.

TABLE 6
Comparison of TPE compositions with silicone
lubricant of varying viscosity

| TPE Compositions | | N | O |
|---|---|---|---|
| SBC Components | SEPTON ™ 4033 | 90 | 90 |
| | SEPTON ™ 4044 | 10 | 10 |
| | Total M3282MZ | 25 | 25 |
| | BRITOL ® 50T | 130 | 130 |
| | L45/10 Silicone | 1.4 | |
| | SF18-350 | | 1.4 |
| | LOXIOL ® HOB7107 | 0.5 | 0.5 |
| | CYANOX ® LTDP | 0.2 | 0.2 |
| | Total | 257.1 | 257.1 |
| Physical Properties | Hardness, Shore A | 33 | 37 |
| | Tensile Strength, psi | 610 | 560 |
| | Ultimate Elong., % | 680 | 670 |
| | Visual Clarity | Clear | Hazy |

Table 6 shows that the TPE compositions blended with low viscosity L45/10 silicone provided the necessary clarity for the TPE plaque sample. In contrast, TPE compositions blended with high viscosity SF18-350 silicone resulted in a hazy TPE plaque sample. It is believed that the lack of clarity of the TPE composition with high viscosity silicone results from phase separation of the silicone from the TPE.

Through extensive and intensive experimentation, the inventor of the present invention has discovered that a thermoplastic elastomer article having high clarity and tensile strength and a hardness of less than 45 Shore A can be formulated by blending two high vinyl SBCs having different molecular weight ranges. In particular, blending at least two high vinyl SBCs, one having a Mn greater than about 120,000 Da and another having a Mn less than about 120,000 Da provides for a TPE article with a hardness less than 45 Shore A, while maintaining adequate haze, temperature stability, moldability, tear strength, and tensile strength characteristics. Such thermoplastic elastomer articles can have a tensile strength greater than 600 psi, a haze less than 20 percent when a thickness of the article is 1.7 mm, and a haze less than 25 percent when a thickness of the article is 3.5 mm, and physical dimensions that remain substantially unchanged after immersion in boiling water (at standard temperature and pressure) for one hour. In addition, the inventor has also discovered that such a TPE composition, when blended with a silicone, requires a low viscosity silicone in order to maintain the desired clarity properties of an article formed therefrom.

In another embodiment, the present invention provides for an article manufactured from a thermoplastic elastomer having specific physical properties, such as a tensile strength greater than 600 psi, a hardness less than 45 Shore A; a haze less than 20 percent when a thickness of the article is 1.7 mm, and a haze less than 30 percent when the article has a thickness of 3.5 mm, as measured by ASTM D1003. In addition, the article's physical dimensions remain substantially unchanged after immersion of the article in boiling water (at standard temperature and pressure) for one hour.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A thermoplastic elastomer composition comprising a blend of:
at least a first and second hydrogenated styrenic block copolymer,
wherein the first hydrogenated styrenic block copolymer has a number average molecular weight less than about 120,000 Da, and greater than about 50 mole percent of a butadiene mid-block copolymerized at the 1,2-position prior to hydrogenation, and/or a butadiene and isoprene mid-block copolymerized prior to hydrogenation, and/or an isoprene mid-block copolymerized prior to hydrogenation, and
wherein the second hydrogenated styrenic block copolymer has a number average molecular weight greater than about 120,000 Da, and greater than about 50 mole percent of a butadiene mid-block copolymerized at the 1,2-position prior to hydrogenation, and/or a butadiene and isoprene mid-block copolymerized prior to hydrogenation, and/or an isoprene mid-block copolymerized prior to hydrogenation;
a polyolefin; and
a plasticizer compatible with the midblocks of the first and second hydrogenated styrenic block copolymers.

2. The thermoplastic elastomer composition of claim 1, wherein the first and second hydrogenated styrenic block copolymers are each independently a SEBS (styrene-ethylene-butylene-styrene) block copolymer or a SEEPS (styrene-ethylene-(ethylene-propylene)-styrene) block copolymer, and wherein the polyolefin is polypropylene.

3. The thermoplastic elastomer composition of claim 1, wherein the first hydrogenated styrenic block copolymer has a number average molecular weight of less than about 115,000 Da.

4. The thermoplastic elastomer composition of claim 1, wherein the first hydrogenated styrenic block copolymer has a number average molecular weight of less than about 90,000 Da.

5. The thermoplastic elastomer composition of claim 1, wherein the second hydrogenated styrenic block copolymer has a number average molecular weight greater than about 130,000 Da.

6. The thermoplastic elastomer composition of claim 1, wherein the second hydrogenated styrenic block copolymer has a number average molecular weight greater than about 150,000 Da.

7. The thermoplastic elastomer composition of claim 1, wherein the composition includes less than about 50 wt. % of the second hydrogenated styrenic block copolymer.

8. The thermoplastic elastomer composition of claim 1, wherein the composition includes about 10 wt. % of the second hydrogenated styrenic block copolymer.

9. The thermoplastic elastomer composition of claim 1, wherein the composition includes greater than about 50 wt. % of the first hydrogenated styrenic block copolymer.

10. The thermoplastic elastomer composition of claim 1, wherein the composition includes about 90 wt. % of the first hydrogenated styrenic block copolymer.

11. The thermoplastic elastomer composition of claim 1, further comprising a stabilizer.

12. The thermoplastic elastomer composition of claim 1, further comprising a lubricant.

13. The thermoplastic elastomer composition of claim 12, wherein the lubricant is a low viscosity silicone.

14. The thermoplastic elastomer composition of claim 13, wherein the low viscosity silicone has a viscosity of less than about 350 cs.

15. An article comprising the thermoplastic elastomer composition of claim 1, wherein the article includes:
a tensile strength greater than 600 psi;
a hardness less than 45 Shore A;
a haze less than 20 percent when a thickness of the article is 1.7 mm, and a haze less than 30 percent when the article has a thickness of 3.5 mm, as measured by ASTM D1003; and
wherein physical dimensions of the article remain substantially unchanged after immersion of the article in boiling water at standard temperature and pressure for one hour.

16. The article comprising the thermoplastic elastomer composition of claim 2, wherein the article includes:
a hardness less than 40 Shore A;
a haze less than 15 percent when a thickness of the article is 1.7 mm, and a haze less than 25 percent when a thickness of the article is 3.5 mm; and
wherein physical dimensions of the article remain substantially unchanged after immersion of the article in boiling water at standard temperature and pressure for one hour.

17. An article comprising:
a thermoplastic elastomer characterized by the following properties:
a tensile strength greater than 600 psi;
a hardness less than 45 Shore A;
a haze less than 20 percent when a thickness of the article is 1.7 mm, and a haze less than 30 percent when the article has a thickness of 3.5 mm, as measured by ASTM D1003; and
wherein physical dimensions of the article remain substantially unchanged after immersion of the article in boiling water at standard temperature and pressure for one hour.
